(19) United States
(12) Patent Application Publication
(10) Pub. No.: US 2026/0356682 A1
(43) Pub. Date: Nov. 12, 2026

(54) PROCESS FOR CO2-NEUTRAL, COMMERCIAL PRODUCTION OF MAGNESIUM WITH LATER RECOVERY OF HYDROGEN AND/OR SYNTHETIC FUELS

(71) Applicant: Rainer Pommersheim, Mainz-Kastel (DE)

(72) Inventors: Rainer Pommersheim, Mainz-Kastel (DE); Denis Breuch, Bingen am Rhein (DE); Holger Löwe, Oppenheim (DE)

(21) Appl. No.: 19/486,173

(22) PCT Filed: May 22, 2024
(86) PCT No.: PCT/EP2024/064021

§ 371 Date: Nov. 20, 2025

(30) Foreign Application Priority Data
May 22, 2023 (DE) 102023113257.1
Jul. 20, 2023 (DE) 102023119209.4

(51) Int. Cl. C01F 5/22; C01B 3/08; C01F 11/18; C22B 3/44; C22B 5/10; C22B 5/18; C22B 26/22

(52) U.S. Cl. CPC C01F 5/22; C01B 3/08; C01F 11/18; C22B 3/44; C22B 5/10; C22B 5/18; C22B 26/22

(57) ABSTRACT

The invention relates to a process for CO₂-neutral, commercial recovery of metallic magnesium from seawater, the recovered magnesium being processed further for use as a raw material for metallurgy and also being usable as a starting material for CO₂-neutral recovery of hydrogen, and the CO₂ recovered or released in the entire process being dissolved and bound in seawater.

The invention relates to a commercial process for CO₂-neutral recovery of metallic magnesium from seawater.

The process is modular and consists of a verification of known technical steps. The individual modules (processes) are not CO₂-neutral and are based on conventional methods that are already technically used. The CO₂-neutrality is achieved by the sequence according to the invention of the individual modules. With favourable selection of the individual process steps, the overall process a has completely CO₂-neutral to CO₂-negative footprint.

The magnesium obtained can be further processed as a raw material for metallurgy. It can also be used as a starting material for CO₂-neutral recovery of hydrogen. The commercial process disclosed here also offers the possibility of producing synthetic fuels, wherein the hydrogen obtained is used as a raw material. In contrast with known commercial processes for producing green hydrogen or synthetic fuels, the process according to the invention does without complex electrolysis steps, which makes it very efficient in terms of energy and costs.

Seawater can absorb very large amounts of CO₂. The absorption capacity increases as the temperature falls and the sea depth increases. Also, according to Henry's law, it is proportional to the partial pressure of the CO₂ in the atmosphere above the water. Even at room temperature and atmospheric pressure, the technical literature assumes approximately 2 grammes of dissolved CO₂ per litre of water, as described in “Carbon Dioxide in Water and Seawater: The Solubility of a Non-Ideal Gas” Marine Chemistry 2 (1974) 203-215. This value also agrees with the results of the inventors' own measurements.

The previously unpublished patent application DE 10 2022 108 490.6 describes a process for recovering Mg(OH)₂ particles from seawater. In this process, large amounts of alkaline wastewater are produced, which can be introduced into the sea.

U.S. Pat. No. 2,167,120 “Process of calcining finely divided calcium carbonate” describes the calcination of calcium carbonate to calcium oxide by way of example. Calcium carbonate compressed into pellets was heated with an airflow at 1100 °C to 1200 °C for 20 minutes and then separated from any impurities by sieving.

Patent EP 0 196 176 A1 “Energy conserving limestone calcining system” describes calcination from 900 °C when the work is carried out in a vacuum and the heat losses are correspondingly minimised.

It is also known from the literature according to “Physicochemical characteristics of fired clay-limestone mixes”; Cement and Concrete Research 30, 7-11 (2000) that complete calcination is possible even at 800 °C.

DE 2 637 504 “Slaking lime” describes the subsequent production of calcium hydroxide. In this case, calcium oxide is introduced into 4 times the amount of water with vigorous stirring for approximately 4 minutes.

Application DE 2 232 355 A1 “Activated magnesia production” describes the calcination of magnesium hydroxide precipitated out of seawater. To produce such activated magnesium oxide, magnesium hydroxide is precipitated out of seawater or brine using milk of lime, its chloride content is washed out to less than 0.7 wt. % NaCl, and it is spray-dried. The dry and fine-grained magnesium hydroxide powder is calcined to activated MgO in an indirectly heated rotary kiln at a temperature of 440-450 °C exhaust gas temperature and while passing through 40 m³/h*kg unpreheated and undried air in cocurrent flow with the Mg(OH)₂.

Patent document U.S. Pat. No. 2,437,815 “Process of Magnesium Production” describes the carbothermal production of metallic magnesium. To achieve the reduction of magnesium oxide with carbon, a temperature above the boiling point of magnesium is necessary to be able to remove the magnesium in gaseous form from the reaction equilibrium. In a furnace with the exclusion of air, a mixture of magnesium oxide and coal is heated to approximately 2000 °C. Since the back-reaction of carbon monoxide with magnesium to magnesium oxide predominates below 1850 °C, the vapour phase is rapidly cooled to approximately 200 °C using natural gas, and the magnesium vapours are thus condensed out.

In U.S. Pat. No. 0,400,309B2 “Carbothermal reduction reactor system, components thereof, and methods of using same” it is shown, using a vacuum system, that magnesium can be produced by this method even at 1500 °C.

Metallic magnesium is processed in large amounts in metallurgy. Under certain conditions, however, magnesium reacts with water vapour to form Mg(OH)₂, releasing hydrogen. The conversion of elementary magnesium is disclosed in the publication “Comparative reactivity of industrial metal powders with water for hydrogen production”; International Journal of Hydrogen Energy 40, 1026-1036 (2015). Hydrogen is produced from magnesium powder and water in a reactor system at 200 °C and 2 to 20 bar positive pressure. This made it possible to obtain up to 0.92 litres (0.041 mol; 0.082 g) of hydrogen per gramme of magnesium.

A long-known technical process for producing synthetic fuels is the Fischer-Tropsch process. It proceeds from CO or CO₂ and hydrogen and provides a mixture of long- and short-chain hydrocarbons, which can be used as fuel for conventional internal combustion engines, among other things.

As explained in patent document DE 293 787 C “Method for producing hydrocarbons and derivatives thereof”, hydrocarbons can be synthesised using the Fischer-Tropsch process from a gas mixture of hydrogen and carbon monoxide at 120 bar pressure and 360 to 420 °C reaction temperature by means of a suitable catalyst, for example cobalt oxide.

Building on the prior art presented above, the object of the invention is to specify a process with the aid of which metallic magnesium can be obtained in a CO₂-neutral manner. This magnesium can then be used, inter alia, to produce green hydrogen, from which synthetic fuels can also be produced in a CO₂-neutral manner.

In the process according to patent application DE 10 2022 108 490.6, in a first step, the seawater is mixed with Ca(OH)₂ until the saturation point is reached. This produces a very high pH, at which all the CO₂ dissolved in the seawater is precipitated out as a solid and is filtered off as CaCO₃. CaCO₃ is a commercial product, which is sold in large amounts worldwide.

In a subsequent step, from the remaining seawater, the Mg⁺⁺ is precipitated out as Mg(OH)₂ from of the MgCl₂ dissolved in the seawater with the aid of special nozzles. For each gramme of Mg(OH)₂, approximately 1 litre of wastewater is produced, which has a pH of approximately 10 and is largely free of CO₂.

If this alkaline wastewater is fed directly back into the sea, the much greater amount of water in the sea will balance its pH again.

However, according to measurements, this alkaline wastewater can absorb relatively large amounts of CO₂ (approximately 2-2.5 grammes of CO₂ per litre), even at room temperature and atmospheric pressure. This is achieved by introducing CO₂ into the water, which dissolves therein. At the same time, the alkaline wastewater is neutralised therewith.

If this process takes place at atmospheric pressure, an equilibrium is momentarily produced, and the CO₂ dissolved in the water will not escape therefrom again. This assumption presupposes that the partial pressure of the CO₂ in the atmosphere does not fall, and that the temperature of the sea remains below the introduction temperature. Since seawater is naturally slightly alkaline, it is additionally ensured that the CO₂ dissolved in the neutralised wastewater remains. If the neutralised water is introduced into the sea at a certain depth, the lower temperature and higher pressure prevailing there additionally ensure that the dissolved CO₂ remains.

If the amount of CO₂ that is released in order to obtain the Ca(OH)₂ from CaCO₃ that is needed to produce 1 gramme of Mg(OH)₂ is compared with the CO₂ absorption capacity of the 1 litre of wastewater that is released per gramme of Mg(OH)₂, it can be seen that this absorption capacity is nowhere near exhausted. Calculations, which agree with the data from the technical literature, have shown that all the CO₂ that is released in the subsequent processes by means of which the metallic Mg is ultimately obtained can additionally be introduced into this wastewater until its neutralisation.

The process steps in the process according to the invention can be described in simplified terms by the following reaction equations:

CaCO₃→CaO+CO₂ 1.

CaO+H₂O→Ca(OH)₂ 2.

Ca(OH)₂+MgCl₂→Mg(OH)₂+CaCl₂ 3.

Mg(OH)₂→MgO+H₂O 4.

MgO+C→Mg+CO/CO₂ 5.

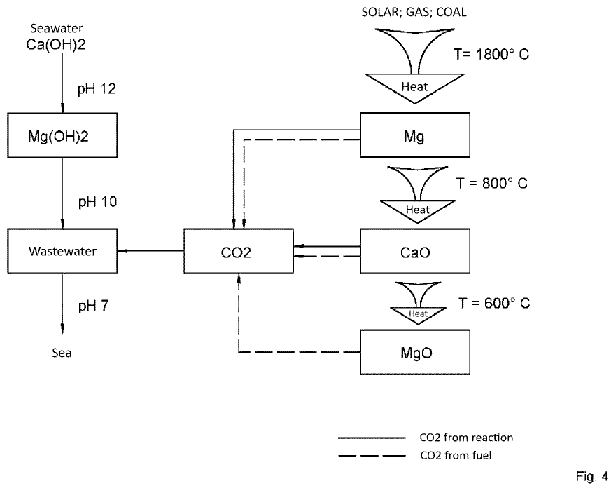

According to the inventive process, all the process steps must be implemented at one location in order to achieve the CO₂-neutrality of the overall process. In particular for process steps 1 and 5, the reactors are built such that, for example, all the released CO₂ is captured in a shell surrounding them. The same applies to the waste gases that are released during the combustion of carbon-containing primary energy carriers that are needed to achieve the corresponding temperatures. The entire amount of CO₂ thus released is collected centrally and, in a specially built mixer, added to the wastewater that is produced during the recovery of Mg(OH)₂ according to step 3 (FIG. 4).

The Mg obtained in step 5 can be used to produce green hydrogen according to the following equation.

Mg+2H₂O→Mg(OH)₂+H2 6.

The above-described recovery of hydrogen can also take place in a decentralised manner at a location other than the production of the Mg. On the basis of the aforementioned equation, mobile, decentralised hydrogen generators are conceivable, which can be operated at other industrial sites, buildings or even vehicles. Since Mg(OH)₂ produced in the process is a commercial product and can also be sold as such.

The process according to the invention also offers the possibility of obtaining synthetic fuels in a CO₂-neutral manner. Starting materials in this case would be CaCO₃, seawater and, for example, coal. The process, which is known as the Fischer-Tropsch process, proceeds according to the following equation:

(2n+1)H₂+nCO→CₙH₂ₙ₊₂+nH₂O 7.

In this case, water vapour would be introduced into the produced reaction gases in step 5 without separating off the CO beforehand. The CO₂-neutrality in this step results from the fact that the CO₂ released in step 5 is not introduced into the wastewater but is bound in the obtained fuel. If the fuel is then burned, it releases exactly the amount of CO₂ that arises from step 5 but was not introduced into the wastewater. The wastewater will therefore absorb from the air exactly the amounts of CO₂ that the fuel emits into the air at another location.

Alternatively, the hydrogen obtained in step 6 could also be reacted with CO₂ from the air at another location, and the CO₂ from step 5 could be introduced into the wastewater. Since the hydrogen according to step 6 is CO₂-neutral, and the amount of CO₂ that the fuel releases on combustion is taken from the air, the fuel would be CO₂-neutral in this case too. The process according to the invention is accordingly composed of known process steps, which are not CO₂-neutral by themselves and only become CO₂-neutral when the released CO₂ is neutralised in the wastewater produced in the process. The steps must be carried out in a certain order so that this can happen. The aforementioned reaction equations are shown in simplified form and describe this sequence. It can be seen therefrom that CO₂ is released in step 1 (equation 1) and step 5 (equation 5). This is then neutralised in the wastewater that is produced in process step 3 (equation 3).

The equations are presented again below with brief explanations:

CaCO₃→CaO+CO₂ 1.

Combustion of limestone at a high temperature to form burnt lime. The limestone (CaCO₃) is decomposed to form burnt lime (CaO) and CO₂. The waste gases produced, which contain the CO₂, are not routed via the roof but captured and neutralised in the alkaline wastewater from step 3.

CaO+H₂O→Ca(OH)₂ 2.

Slaking of burnt lime to form calcium hydroxide (Ca(OH)₂). When burnt lime comes into contact with water, calcium hydroxide is produced, releasing heat. In the process according to the invention, the burnt lime can also be added directly to the seawater.

Ca(OH)₂+MgCl₂→Mg(OH)₂+CaCl₂ 3.

Precipitation of the magnesium-containing particles out of the seawater. The Ca(OH)₂ (calcium hydroxide) is added in amounts below its solubility limit to the seawater, whereby the pH thereof is raised to 12. This alkaline seawater prepared in this way reacts with the magnesium chloride, which is dissolved in a second stream of seawater, at the outlet of a nozzle. The magnesium hydroxide precipitates out, resulting in alkaline seawater with a pH of 10, in which the CO₂ produced in the process is neutralised.

Mg(OH)₂→MgO+H₂O 4.

Combustion of magnesium hydroxide to form magnesium oxide. When the Mg(OH)₂ from step 3 is heated, it is converted into magnesium oxide (MgO), releasing water vapour, which can be condensed and used for further steps.

MgO+C→Mg+CO/CO₂ 5.

Thermal reduction of magnesium oxide to form magnesium (carbothermal process). The magnesium oxide is heated very intensively in the presence of carbon. This produces magnesium vapour and carbon monoxide. The magnesium vapour is condensed to form metallic magnesium, and the carbon monoxide may be converted to CO₂. The CO₂ is captured and neutralised in the alkaline wastewater from step 3.

Mg+2H₂O→Mg(OH)₂+H2 6.

Oxidation of magnesium with water vapour (water splitting process). When magnesium powder is heated in the presence of water vapour, it reacts to form magnesium hydroxide and hydrogen.

(2n+1)H₂+nCO→CₙH₂ₙ₊₂+nH₂O 7.

Synthesis of hydrocarbons from hydrogen and carbon monoxide (Fischer-Tropsch process). Under certain conditions, the hydrogen from step 6 and the carbon monoxide from step 5 react to form hydrocarbons, which can be used as synthetic fuels, for example.

The obtained Mg(OH)₂ can be fed back into the process and used for more production of magnesium, which can then be sold in addition to hydrogen. The background of this is as follows:

In step 6, 1 mol Mg, i.e., 24 g magnesium (molar mass of Mg: 24 g/mol), produces 1 mol H₂, i.e., 2 g hydrogen (molar mass of H₂: 2 g/mol). The mass of the obtained hydrogen is therefore only around 1/12 of the mass of the magnesium used.

Assuming current world market prices of approximately 3000 €/t for Mg and approximately 6000 €/t for hydrogen, 6000 € worth of hydrogen would be obtained from 36,000 € worth of magnesium. If the Mg(OH)₂ is fed back into the process and passed through the cycle once, the process becomes very lucrative, since the hydrogen is obtained virtually free in addition to the magnesium.

The hydrogen is obtained in the first pass according to the graphic (numbers 1), and the magnesium that can be sold is not produced until the second pass (numbers 2). The process then begins again from the start with the seawater and the lime. The invention shall be explained in more detail using drawings and examples.

### EXAMPLE 1

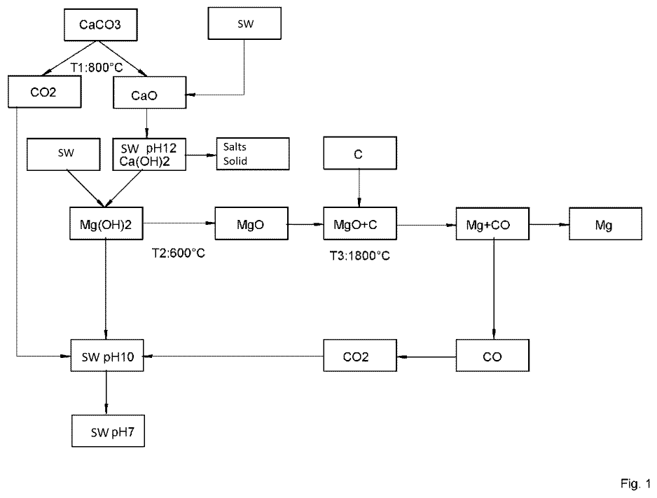

FIG. 1 schematically shows the process according to the invention until the metallic magnesium is obtained.

In a first step, a saturated Ca(OH)₂ solution (solution 1) is produced from seawater (SW) and Ca(OH)₂. The 1.7 g/litre of Ca(OH)₂ required for this were previously obtained by burning CaCO₃ to form Cao, which has converted into Ca(OH)₂ on contact with the seawater (SW). In the process, a considerable amount of energy in the form of heat is released.

A mixture of salts, which also contains large amounts of Ca(CO)₃, precipitates out. This can be purified and sold as a commercial product.

According to the “Informationsblatt CO₂-Faktoren” [Factsheet on CO₂ Factors] published by the German Federal Office for Economic Affairs and Export Control, 0.89 tonnes of CO₂ are released per tonne of Ca(OH)₂ obtained. Accordingly, 1.7*0.89=1.513 g CO₂ are released in the production of the aforementioned 1.7 g/litre of Ca(OH)₂. Solution 1 is then reacted with fresh seawater (SW) in a ratio of 2:1, wherein approximately 1 gramme/litre of Mg(OH)₂ precipitates out. The obtained Mg(OH)₂ particles are separated out by filtration. A 3 litre suspension is thus obtained, during the preparation of which 2*1.513 g CO₂, i.e., 3.026 g CO₂, were released. Accordingly, 3.026 grammes of CO₂ were released for the 3 grammes of Mg(OH)₂ present in the suspension. The aqueous phase produced after the Mg(OH)₂ has been filtered off originally has a pH of approximately 10. If its pH is then reduced to a neutral pH of 7 by dissolution of CO₂, the inventors' own measurements have shown that approximately 2-2.5 grammes of CO₂ per litre are dissolved therein at room temperature and atmospheric pressure.

In the subsequent step, the Mg(OH)₂ particles thus obtained are burnt to form MgO particles by heating to approximately 600 °C. The MgO is then mixed with coal dust and reacted at approximately 1800 °C. A gas mixture results that contains Mg in vapour phase and CO. The magnesium is separated from the co gas by condensation. Instead of the aforementioned coal dust, carbon from any other source can be used. For example, biomass or products from combustion plants can be used.

According to the list of emission factors published by the German Federal Environment Agency, natural gas emits 0.055 tCO₂/GJ, and coal emits 0.095 tCO₂/GJ. On the basis of these data, 0.14 g of CO₂ from natural gas or 0.24 g of CO₂ from coal is released per gramme of Mg(OH)₂ used, in order to generate the amounts of heat needed for the aforementioned processes. Additionally, 0.754 g of CO₂ is released per gramme of Mg(OH)₂ during the reaction of the MgO obtained from the Mg(OH)₂ with coal.

All the CO₂ produced during the process according to FIG. 1 is captured and mixed with the alkaline wastewater produced during the precipitation of the Mg(OH)2.

If all these CO₂ emissions are taken into account and offset by the amount of CO₂ that can be absorbed (dissolved) in the alkaline wastewater produced to obtain 1 gramme of Mg, the following picture results:

According to the list of emission factors published by the German Federal Environment Agency, −0.04 g of CO₂ is released per gramme of Mg if the required amount of heat is produced using natural gas, while it is +/−0.00 g of CO₂ per gramme of Mg if the same amount of heat is obtained from coal. In each case, the process is therefore CO₂-neutral.

The conditions on which the above calculation is based describe a worst case scenario. The CO₂ footprint of the overall process can be improved much further if the following aspects are optimised:
1. Fuels: If, for example, natural gas is used instead of coal to provide the heat needed in the process, only 0.055 t of CO₂ instead of 0.095 t of CO₂, i.e., just over half, is released per GJ of heat obtained, according to the list of emission factors published by the German Federal Environment Agency. There is also the possibility of obtaining the required heat by solar thermal energy in so-called solar furnaces. The emissions for obtaining heat would thereby be reduced to virtually zero. In this case, the CO₂ footprint would be improved to −0.120 g of CO₂ released per gramme of Mg.
2. Heat recovery (FIG. 4): Most of the thermal energy is needed for obtaining the metallic Mg from MgO. The waste heat resulting from this step could be used, for example, to operate the kilns for producing the CaO from CaCO₃. The waste heat from this process step could also for its part be used to convert the Mg(OH)₂ to MgO. The waste heat produced in this process step would presumably be sufficient to dry the Mg(OH)₂. The waste heat could also be used to produce steam, with which the electrical energy needed for the process could be provided. If the waste heat from the individual process steps is recovered, approximately −0.08 grammes of CO₂ with natural gas as fuel and approximately −0.06 grammes with coal as fuel would be released per gramme of Mg. In each case, the CO₂ footprint becomes negative, i.e., more CO₂ is bound in the process than is produced when the process is carried out.
3. Carbon source: If carbon that is obtained from renewable rather than fossil sources, for example biomass, is used in the described process, the CO₂ footprint can be improved much more.

### EXAMPLE 2

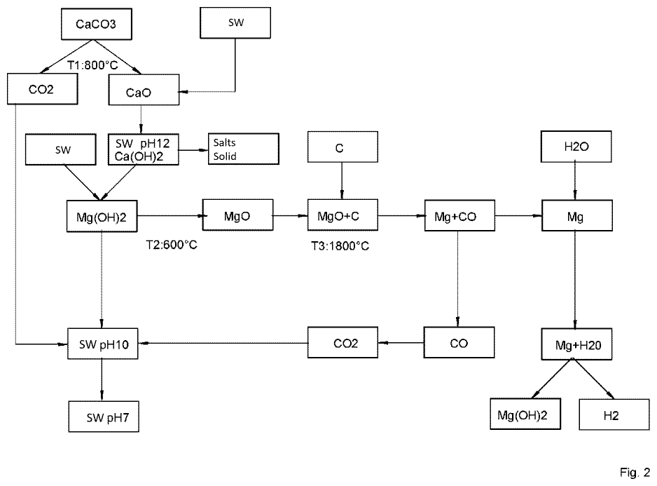

FIG. 2 shows the process from FIG. 1 in which the obtained Mg is brought into contact with water vapour in a further step. Hydrogen and Mg(OH)₂ are produced. The process for obtaining the necessary Mg from FIG. 1 is CO₂-neutral, as explained above. Since no further CO₂ is released when the hydrogen is obtained, the process of FIG. 2 is also CO₂-neutral.

### EXAMPLE 3

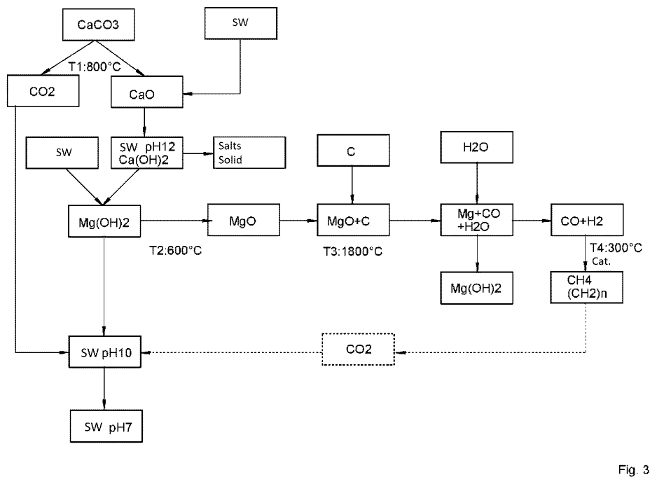

FIG. 3 schematically shows a process in which the hydrogen that is obtained by the process of example 2 is converted into fuel by a Fischer-Tropsch process.

Unlike the process of example 2, the Co that is produced during the reaction of Mg with carbon is not removed from the mixture but is introduced directly into water vapour. This produces Mg(OH)₂, which is separated out as a solid, and a gas mixture, which contains CO and H₂. This is converted into fuel by a Fischer-Tropsch process. The CO₂ released during the process is bound in the fuel for now. It is released when the fuel is burnt. Since the amount of CO₂ then released is not added to the wastewater as in examples 1 and 2, this wastewater can absorb an equivalent amount of CO₂ from the atmosphere. The fuel thus obtained is therefore likewise CO₂-neutral.

If CO₂ from other sources, such as the atmosphere, is used for the described synthesis, the direct CO₂ footprint of the process can be additionally improved. In such a case, the CO₂ from the preceding process steps is then added to the wastewater.

1. A process for CO₂-neutral recovery of metallic magnesium from seawater, comprising the following steps:
mixing an amount of seawater with Ca(OH)₂ until the saturation point is reached;
precipitating out the CO₂ dissolved in the seawater as a solid and filtering it out as CaCO₃;
precipitating out Mg⁺⁺ as Mg(OH)₂ from the MgCl₂ dissolved in the seawater;
obtaining an alkaline wastewater with a pH of substantially 10;
capturing or generating the CO₂ released in preceding or following process steps for obtaining magnesium;
introducing the CO₂ into the alkaline wastewater, wherein the CO₂ dissolves in the wastewater, and the wastewater is neutralised, wherein the introduced CO₂ remains bound in the wastewater;
transferring the now neutralised wastewater into in particular relatively deep sea zones to secure the dissolved CO₂.

2. The process according to claim 1,
characterised in that
the obtained magnesium is mixed with water to obtain Mg(OH)₂ and hydrogen as energy carriers.
